(19) United States
(12) Patent Application Publication
(10) Pub. No.: US 2009/0012806 A1
(43) Pub. Date: Jan. 8, 2009

(54) System, method and apparatus for data capture and management

(76) Inventors: Camillo Ricordi, Miami, FL (US); Stephen William Anthony Sanders, San Francisco, CA (US); Steven Brian Sikes, Miami, FL (US)

Correspondence Address: Mr. Steven Sikes, 4070 Woodridge Road, Miami, FL, 33133, US

(21) Appl. No.: 12/132,619

(22) Filed: Jun. 4, 2008

Related U.S. Application Data
(60) Provisional application No. 60/943,062, filed on Jun. 10, 2007.

(51) Int. Cl. H04L 9/32; G06F 17/30; G06F 7/06; G06F 21/00; G01S 1/00; G06Q 99/00

(52) U.S. Cl. 705/1; 707/10; 713/170; 707/5; 726/7; 342/357.07; 707/E17.014

(57) ABSTRACT

A method and system and apparatus for capturing, accessing, securing, personalizing and organizing data and content. The system includes a plurality of mobile computing devices. Each mobile device preferably includes a personalized interface for multiple input data capture and includes a system for transmitting the content and information to a secure server network, a system for organizing the data and information into personalized modules, and a means for transmitting the content to third parties for authentication and time/date stamping and registration. Said apparatus captures stores, secures, and sends data and information via wireless transmission means and/or networked means, to a mobile device and/or secure server to facilitate discovery and or innovation.

### CROSS REFERENCE TO RELATED APPLICATIONS

This application claims priority under 35 U.S.C § 119(e) to U.S. Provisional Application Ser. No. 60/943,062, entitled “A system, method, and apparatus for data capture and management,” filed Jun. 10, 2007, the entire contents of which are hereby incorporated by reference.

### FIELD OF THE INVENTION

This invention provides a system, method and apparatus for capturing, aggregating, presenting, sharing and securing data via a portable computing device and uploading said data to smart phones, mobile communication devices, PCs, PDAs, handhelds, and tablets. More particularly, the invention delineates a system for tagging, identifying authenticating, organizing and personalizing collected and captured data based on user profiles and information.

### DESCRIPTION OF THE RELATED ART

The invention relates to a system and method and apparatus for capturing, organizing, securing and sharing data utilizing a mobile computing device and uploading said data to smart phones, mobile communication devices, PCs, PDAs, handhelds, and tablets. Said system and method for capturing data will enable a user to gather and collect information and data via multiple inputs and slots on a mobile computing device, and to adjust settings on a user interface to aggregate said data into personalized and customized modules, thereby allowing a user to indicate a secure location to transmit the content and information. Users of said system and method shall be able to store a subset of key phrases in a data structure for subsequent searches and also to identify said data structures with tags and phrases for archiving, while generating a mobile record for identification, location, and dates in order to facilitate tracking and securing the protection and documentation of information including optional third-party verification and time-stamping of data uploads to a secure server. Data may be exported into a directory on said mobile computing device or devices and backup copies may be created, and transmitted to, and stored on, a secure server that is configured to facilitate the sharing and grouping of similar sets of data. Said system and method delineates a system for tagging, identifying, authenticating, organizing and personalizing collected and captured data based on user profiles and information and also it also facilitates the sharing and protection of data by allowing capturers of said data to define the parameters wherein said data may or may not be shared or viewed by others.

Said system and method optimizes data collection, ideation, idea protection and retrieval, and organizes “jots”, i.e., notes, ideas and digital data entries into a secure environment, for fast and easy access after authentication via various secure technologies, including digital signatures, encrypted passwords, biometrics or voiceprints. Digital data entries could include the use of devices such as portable scanners, digital cameras or USB eyepiece connections to enable uploading of images from microscopes and other digital imaging tools, including but not limited to video, voice recording, imaging and data analysis devices and equipment (e.g., EM, SEM, fluorescence microscopes, FACS, Laser Scanning Cytometers and Multiphoton Confocal Microscopes, Light Cyclers, quantitative and semiquantitative gene expression technologies). Presently, laboratory data recording and collection still relies on primitive paper-based laboratory notebooks, which are often bulky with numbered pages that require including times and dates and validating signatures for each page data entry. Documentation using this manual process is time consuming and presents significant problems and challenges, including: possible inaccuracies in data transcription; lost data, because researchers, investigators and personnel are rarely able to document all of their activities; insufficient or improperly maintained records; and potential incompliance with legal and regulatory requirements or guidelines. Therefore, said system and method intends to mitigate said challenges, by allowing the capture, integration and organization of digital data entries from multiple sources, from the simplest hand-scribbled note on a tablet computer to complex imaging and data analysis entries. This system, namely a cross platform software application, could be used with any existing computer or hand held device, or be used in conjunction with a specific apparatus that could allow data capture from the abovementioned digital sources (e.g., a hand-held device that allows a scan of sections of documents, text or images, which also includes a voice recording feature, a video capturing component, a data entry port and the ability to take hand written notes or drawings like a small tablet computer).

### BACKGROUND OF THE INVENTION

There exists a variety of electronic systems for collecting, storing and authenticating data. These systems include the electronic lab notebooks (ELN) that are used primarily by companies in the life sciences sector. Often these systems are content-specific, i.e., they focus on certain fields such as chemistry, biology, and genetics, and the systems are customized and integrated within the companies' informatics and R&D departments.

As an alternative to paper-based documentation, many organizations and firms are utilizing electronic lab notebooks to improve record-keeping, to verify contributions by individuals, and to serve as evidence in any future patent or legal dispute. Moreover, many companies in the life sciences sector have been turning to Laboratory Information Management Systems (LIMS) for aggregating and managing lab data. These systems aim to integrate and manage data in specific areas on a large scale, or based on specific project requirements, but they do not fully address the needs of researchers, investigators or scientists working on projects requiring multiple data entries from several sources, nor do they provide the most optimum platform for said parties to document and secure novel ideas and confidential information.

Academic institutes have been slow to adopt digital and electronic lab notebooks, primarily because of the costs involved in customization and integration, however, the costs to implement paperless research have dropped considerably, especially due to advances in mobile technology, reduced time cycles to develop mobile applications, increased compatibility across platforms, and technological advances for enhancing data security through encryption and authentication tools.

Intellectual property assets and patentable ideas are the building blocks for facilitating novel discoveries, scientific advances and accelerated cures. Ideas often need to be documented and legally protected before they can be shared. Filing a single patent can consume months of a researcher's time, whereas digital notebooks and mobile data capturing tools can help streamline the filing of patents by using templates and modules to store, aggregate and organize data and information. The real value of a digital system lies in securing confidential information in a personalized environment. From a legal perspective, the ability to identify the creators and originators of ideas, and the concomitant dates, locations, and information involved in the discovery process is relevant for establishing intellectual property protection and ownership rights. Moreover, a mobile computing device provides more opportunities for point-of-discovery data capture, especially while collecting new ideas and thoughts during lab protocols, field research, clinical trials, or while on the go.

Scientists and researchers lose valuable time trying to locate ideas, information and data; they often misplace content and often have difficulties deciphering hastily scribbled notes and jottings. Developers are utilizing emerging and maturing Web 2.0 and Mobile 2.0 tools to create user-friendly applications that are enabling scientists and researchers to capture and share information while going mobile. As the content creators and idea originators, these researchers, scientists, and investigators can choose the parameters for potential integration and collaboration.

Research institutes need to protect confidential information and data with greater security and advanced authentication tools. If unauthorized users gain access to key data, they can disrupt the discovery process, corrupt or delete information, or utilize the content for unethical or self-serving purposes.

In current research environments, there is “information overload”, where disparate data needs to be edited, consolidated, categorized, tagged and organized. Paper-based documentation often does not satisfy the commercial and scientific needs of organizations—and many organizations and research institutes have resorted to outsourcing or developing digital or electronic platforms and applications to capture, store, search, and secure content, thoughts and ideas.

Digital platforms support a wide range of information protocols. Such platforms and applications accelerate the dissemination of information to relevant parties, including colleagues, supervisors, legal experts, notaries, partners, and informatics and administration personnel. Moreover, the automated registering of content and metadata, time-stamping data, and delineating audit channels reduce potential conflicts and disputes, while increasing workflow and productivity.

Advanced mobile technologies enable researchers to capture information and data via multiple inputs on devices and tablets, including imaging, recording, scanning, and documenting entries. These technologies enhance the real-time capture and dynamic protection of Intellectual Property assets and facilitate viable paths to commercializing these assets through grants, product development, licensing and other potential revenue-generating streams.

The mobile communication device is the indispensable tool for the 21^{st} century. It has supplanted the PC as the premier communication instrument worldwide. More people are accessing the web via mobile phones and they are utilizing embedded and integrated functionalities, including GPS tracking, multimedia, gaming, banking, social networking, location-based services, telemonitoring, and medical record-keeping. The mobile generation will continue to embrace applications which will enhance productivity, provide entertainment, streamline activities, present opportunities, increase security and diminish risks. The Smart Mobile Data Notebook (SMDB) is the ideal system and apparatus for busy scientists and researchers seeking to transform their inspired findings and diligent work efforts into organized modules, managed results, and detailed research publications.

Therefore, there exists a need for a system that is effective at capturing information, thoughts, ideas and data in multiple formats, and organizing, securing and authenticating the data within a mobile device or apparatus, fulfilling standards and regulations, and customizing an interface for specific user and organizational needs and preferences.

### REFERENCE PATENTS & PRIOR ART

U.S. Patent Application No. 20050216830 (Turner, Jeffrey Scott; et al.), expressly herein by reference, relates to a tool for facilitating the “exchange of data to and from an end-user application to one or more corporate data files without the end-user's direct use of the corporate data tool used to create and maintain the corporate data files”. This existing art works without the need of the end-user to be familiar with the particular corporate data tool or how to connect to the one or more corporate data files (such as a database). Although this existing art does allow for data-tagging and for users to enter data into a template it does not mention nor consider the sharing or profiling of data or data access, nor does it mention mobile communication devices, not the protection and/or sharing of data related to discovery or research purposes.

U.S. Pat. No. 6,895,507 (Teppler, Steven W.), expressly incorporated by reference, delineates a system and method for providing trusted time in content of digital data files in which a series of sub-systems are employed to time stamp data and to provide a certificate; however, this existing art focuses primarily in voting systems and voting machines and although intended to provide timestamps on digital data entries, it makes no mention of communication systems or sharing data with others in the spirit of collaboration or discovery. The existing art does not mention compiling tagged data from multiple sources.

U.S. Pat. No. 7,206,789 (Hurmiz, et al.), expressly incorporated by reference, relates to a system and method for aggregating data in a shared database information system. This existing art provides a database development and management tool that enables a user to develop a customized interface to a database within an information management system. Customization can be implemented at an individual or community level and database views can be produced and customized to support different services and/or the diverse needs of a plurality of user communities. Although this existing mentions more than one user entering an online database, an emphasis is placed on users customizing the data itself to organize it into a form of logical database as opposed to collecting, archiving and comprising data for the process of compiling, protecting and tagging data specifically for facilitating discovery, innovation or for protecting Intellectual Property.

U.S. Patent Application No. 20070083393 (Howell, Michael), expressly incorporated by reference, describes a system and method for generating an electronic mobile record which is accessible to authorized users. This existing art is geared toward information, such as insurance information, demographic information, personal information, medical history information, physician contact information, donor information, appointment information, therapy management information, emergency contact information, and the like. This existing art transfers facts to and from other systems linked to the network to and from the record with an emphasis on capturing medical records and files for the sake of managing a back office as opposed to organizing, archiving and sharing data from mobile devices for the sake of discovery. Moreover, no mention is made of organizing data for means other than organized storage, and no mention exists of supporting or employing mobile devices. The existing art makes no mention of organizing, tagging or sorting data to pursue the filing and/or protection of Intellectual Property.

### SUMMARY OF THE INVENTION

The invention provides a system and apparatus which facilitates multi-input data capture via a mobile computing device and uploading said data to handhelds, PCs, PDAs, smart phones and tablets, and the secure storage of information and content within a robust relational database.

In another embodiment, the system provides an intuitive customized interface for accessing, reviewing, revising and sharing said data and information, and it enables the transmission of said data to designated third-parties, including but not limited to colleagues, supervisors, project managers, attorneys, and notaries, for review, evaluation and time/date stamping of said data and information.

The invention optimizes data collection, idea creation and retrieval, and organizes said data into a secure archived environment for fast and easy access after authentication via a plurality of methods, including digital signatures, encrypted passwords, biometrics or voiceprints.

The following components are also part of the invention system:
A multi-input system which captures, stores, secures, and organizes said data, tracks entries relevant to the user and aggregates said data and information and provides date and time of idea creation and disclosure, and identifies a plurality of users who have accessed, viewed or contributed comments or annotations to said documents and data;
An FDA CFR21 part 11 compliant system that supports the standards and regulations associated with capturing and accessing ideas and content in a secure and reliable manner utilizing digital signatures and authentication tools, organizes content and information via access logs and data feeds, and facilitates the evaluation and customization of ideas and content into an expert document index which provides an analysis of said documents and content and what steps, if any, should be taken to pursue the commercialization or development of said ideas; and it provides a method for the time-stamping and registering of documents by a third-party provider.
A personalization object-oriented index which creates a personalization object for every user, wherein said data and entries can be cross referenced with other data and information, and embedded and tagged with identifiers, evaluation, and references.

The invention also includes a method for the personalization of all search queries comprising embedding said data and content from digital sources. By utilizing smart queries, users can conserve valuable time and resources by accessing and locating specific user-centric information and data.

The data captured and generated by the invention is designed to be integrated and deployed via most wireless communication standards, with embedded security and encryption functionalities that enable confidential data and information to be transmitted according to the standards set by the FDA as well of the standards of the user organizations. If data comprises sensitive patient information derived from research protocols and clinical studies, said data will follow the standards set by the Health Insurance Portability and Accountability Act (HIPAA).

Another embodiment of the invention includes a facility, institute and researcher locator, combining GPS (global positioning system), geo-location technologies, and virtual mapping applications with tagged and embedded data and information. Geo-tagging the data facilitates the organization of data objects based on location. Moreover, the embedded GPS component can be utilized to locate or retrieve the apparatus if it is lost, misplaced, or stolen. Additional hybrid applications comprise organizing captured data into slide show and multimedia formats and facilitating collaboration among multilingual parties and researchers by utilizing automatic translation of tagged data and information.

Another embodiment of the invention includes an apparatus that captures, stores, secures, and organizes said data, tracks entries relevant to the user and aggregates said data and information and provides date and time of idea creation and disclosure, and identifies a plurality of users who have accessed, viewed or contributed comments or annotations to said documents and data.

Another embodiment of the invention includes an apparatus that captures, stores, secures, and sends captured and secured data via wireless and electronic transmission to facilitate discovery and accelerate commercialization. Said apparatus may be in multiple formats and embodiments, including but not limited to, the shape of a pen and said apparatus will be able to capture a plurality of data objects in a plurality of formats including but not limited to written text, standard photographable and scanned images, recordings, and visuals captured via a plurality of a means, including but not limited to lens, digital imaging tools the capturing of audio information and data analysis devices and equipment (e.g., EM, SEM, fluorescence microscopes, FACS, Laser Scanning Cytometers and Multiphoton Confocal Microscopes, Light Cyclers, quantitative and semiquantitative gene expression technologies). Said apparatus will have the ability to send said captured data to a mobile and/or handheld device for the compilation and aggregation of said data and the subsequent facilitation of the discovery process and the acceleration of commercialization. Said apparatus will have variable settings that will be activated by one-touch capability to select and/or toggle between said apparatus's ability to capture a plurality of data objects, including but not limited to ideas, thoughts, text, visuals, and sounds.

Furthermore, said data capture apparatus may be multi-shaped and multidimensional. In general, said apparatus will be comprised of a body and a display and scanner screen in which the user may view digital information regarding settings, information and the functioning of the apparatus itself, as well as allowing the user to scan information, including but not limited to text, and other images. Said apparatus will contain a USB-style data and scanner port or other type of data port that facilitates the transfer of data from said apparatus to other hardware and/or data processing devices, and it will also facilitate the uploading and downloading of data and/or software from said device and it will enable sending or receiving scanned data and images. Said data capture device will contain a battery to power said device, a wireless radio for transmitting wireless data, and a processor and memory storage unit. Said wireless radio will promote the sending and receiving of wireless data over multiple networks, mediums and platforms, including but not limited to Wi-Fi, Bluetooth, GSM, CDMA, 3G and Wi-Max standards. An image and video capture device is connected to an image and video capture lens that enables said apparatus to collect a plurality of images and sounds. Said image and capture lens may be used to capture an image of biometric information including but not limited to one or more fingerprints, or a plurality of iris scans in order to either collect such data or use it to verify, identify and authenticate the user of said device. Said device may contain a retractable stylus tip to facilitate the use of using touch screen devices, including but not limited to wireless mobile devices. Said apparatus may contain a retractable writing tip, including but not limited to an ink writing tip, as is used by most pens. A retractable device controller is used to retract and protrude said retractable stylus tip and/or said retractable writing tip. Said data capture apparatus also entails a global positioning system (GPS) component that will enable said device to be located if lost or misplaced, and it will facilitate geo-tagging which will capture device location and user location in conjunction with time stamping and data capture and upload. Said device also entails a memory stick port which will allow data to be sent and received from said device by use of a removable memory stick and/or hardware accessory. A microphone—sound port is provided to allow the recording of voice and sound as well as the playback of said recordings or to provide audible instructions or information, including but not limited to alerts, instructions or notifications. An eye-piece-style adaptor further enables said device to connect to various hardware and instruments, including but not limited to microscopes. Said eye-piece-style adaptor will facilitate the collection and storage of data, including biometric data. Said data intended for capture by use of said eye-piece-adaptor, and/or said image and video capture lens may be displayed on said display and scanner screen prior to, during, and after said data capture is completed. Furthermore, said display and scanner screen may be used to read and capture biometric data including but not limited to one or more fingerprints, and a plurality of iris scans, in order to capture information or to use it for access authentication. A username and security password may be required in order to allow access to said device and related information for gaining device and/or system access may be displayed on said display and scanner screen.

### BRIEF DESCRIPTION OF THE DRAWINGS

FIG. 1 is a flow chart depicting the overview of the data upload process of the preferred embodiment.

FIG. 2 is a flow chart depicting the registration process of the preferred embodiment.

FIG. 3 is a flow chart depicting the profiling process of the preferred embodiment.

FIG. 4 is a flow chart depicting the matchmaking process of the preferred embodiment.

FIG. 5 is a flow chart depicting the authentication process of the preferred embodiment.

FIG. 6 is a flow chart depicting the archiving process of the preferred embodiment.

FIG. 7 depicts a data capture apparatus.

### DETAILED DESCRIPTION OF THE PREFERRED EMBODIMENTS

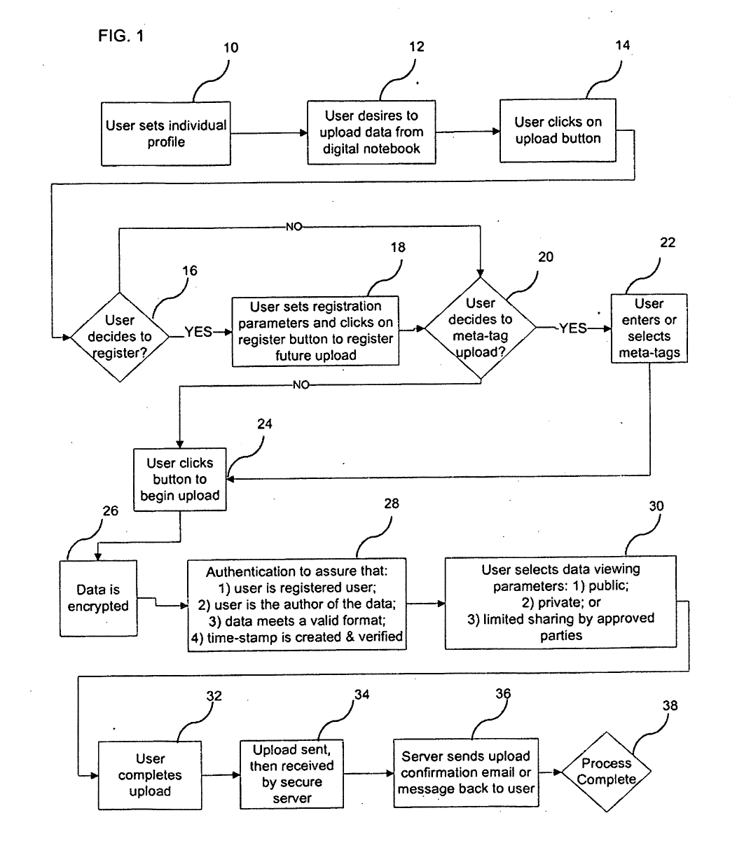

FIG. 1 depicts the overview of the data upload process of the preferred embodiment where a user sets an individual profile 10 and then user desires to upload data from a digital notebook 12, and shall click on an upload button 14. At this point said user must decide to register 16. If said user decides to register then said user sets registration parameters and clicks on register button to register future upload of data 18. At this point said user must decide to meta-tag data to be uploaded 20, and if said user desires to meta-tag data then user enters or selects meta-tags 22. At this point, said user clicks button to begin the upload process 24, after which said data is encrypted 26, and then authentication is started to assure that said user is properly registered, that said user is the author of said data, that data meets a valid format, and/or that a time-stamp is created and verified 28. Now, said user selects data viewing parameters that range from private to public to viewable only by approved parties 30. Said user now completes data upload 32 and upload is sent to a secure server 34 which may send said user an email or text and/or voicemail confirmation of a successful, timestamp and confirmed upload 36, after which process is complete 38.

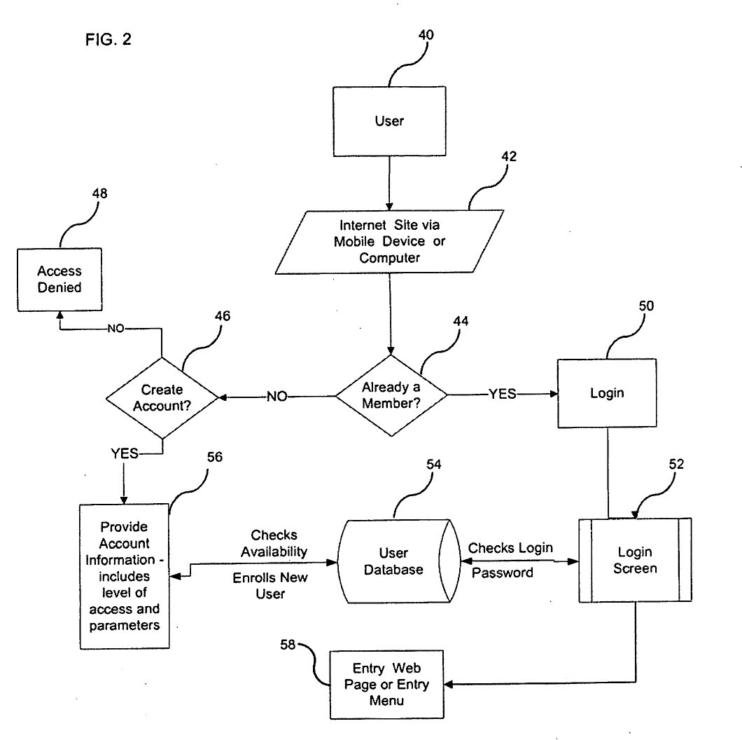

FIG. 2 depicts the registration process where a user 40 enters an Internet site via mobile device or computer 42. If the user is not already a member then said user may decide to create an account 46. If an account is not successfully created access will be denied 48. If the user is already a member, they will arrive at a login screen 50. Users that are not members that wish to create an account may be able to provide account information 56 and to successfully arrive at a login screen 52 after which said user may access entry web page or entry menu 58.

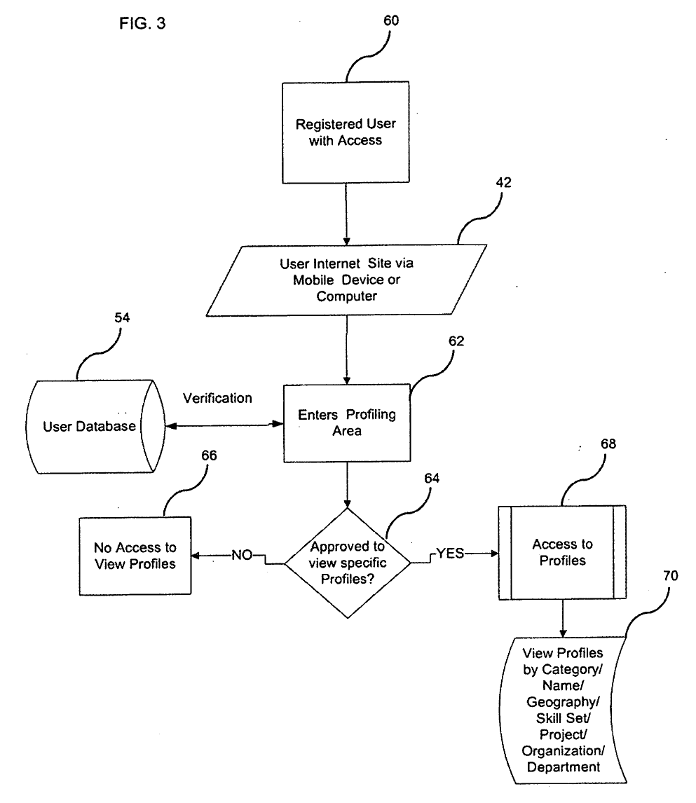

FIG. 3 depicts the profiling process whereby the registered user with access 60 enters the user Internet site via a mobile device or computer 42 and then thereby enters a profiling area 62 to be verified against the user database 54. At this point said registered user with access 60 must be approved to view specific profiles 64, and if not approved then no access to view profiles 66 is granted. If said registered user with access 60 is approved to view specific profiles 64, then access to profiles 68 is awarded and then said user with access 60 may then view profiles by category/name/geography/skill set/project/organization/department and/or other parameters 70.

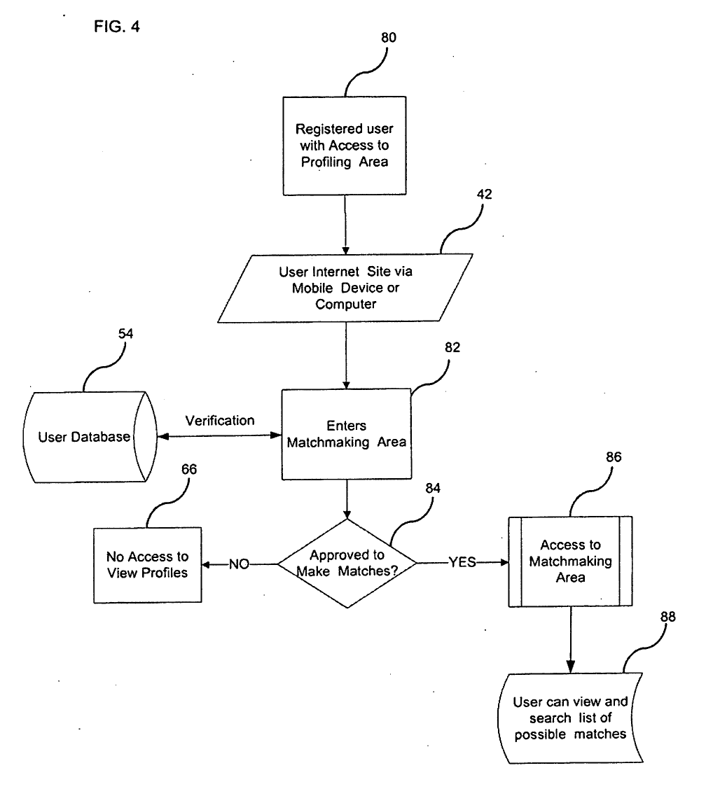

FIG. 4 depicts the matchmaking process whereby a currently registered user with access to profiling area 80 enters the user Internet site via mobile device or computer 42, and subsequently enters the matchmaking area 82 were said currently registered user with access to profiling area 80 is then verified against the user database 54. Post verification said currently registered user with access to profiling area 80 must be approved to make matches 84. If said currently registered user with access to profiling area 80 is not approved then no access to view profiles 66 is granted. If said currently registered user with access to profiling area 80 is approved then access to matchmaking area 86 is granted, and thereby said user can view and search list of possible matches 88.

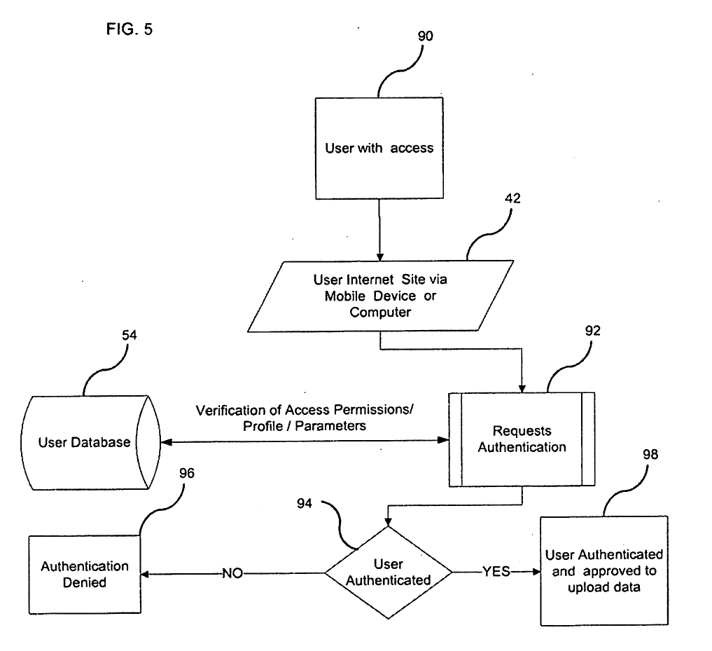

FIG. 5 depicts the authentication process whereby a currently registered user with access 90 enters the user Internet site via mobile device or computer 42 and requests authentication 92. At this time, verification of access permissions/profiles/access parameters are performed and matched against the user database 54. If authentication is allowed 94 then said user is allowed to upload data 98. If authentication is not allowed then it is denied 96.

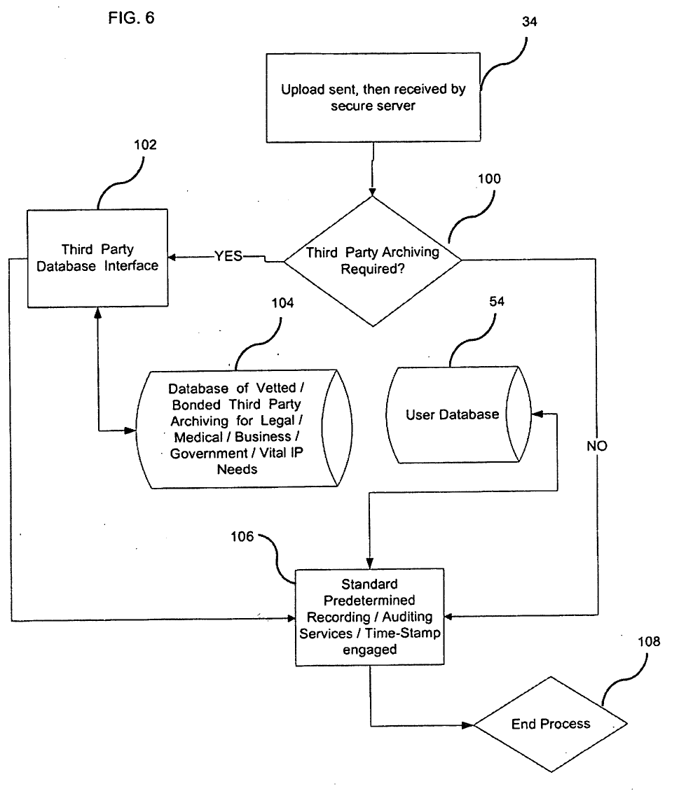

FIG. 6 depicts the archiving process whereby an upload is sent, then received by a secure server 34. If a third-party archiving is not required 100, then standard predetermined recording/auditing services and time-stamping are engaged 106, after which said process is ended 108. If third-party archiving is required 100; then a third-party database interface 102 will access and update a database of vetted/bonded third-party archiving for legal/medical/business/government/vital Intellectual Property needs 104, and then standard predetermined recording/auditing services and time-stamping may still be engaged 106, after which said process is ended 108.

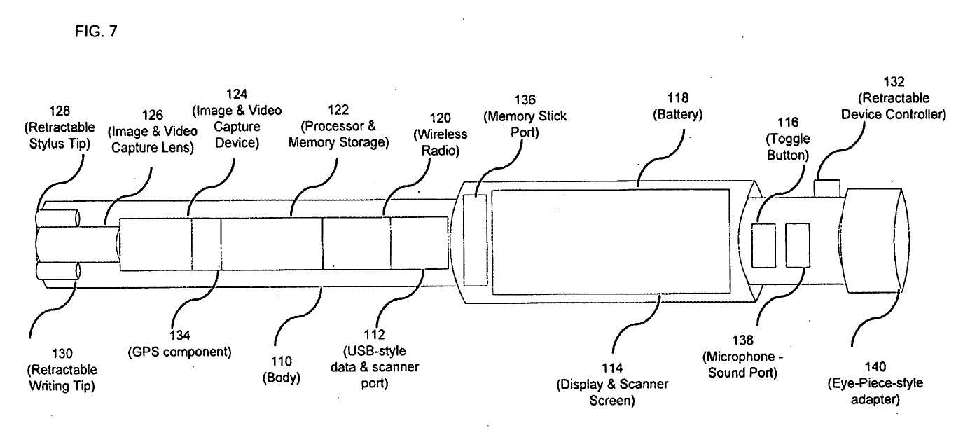

FIG. 7 depicts a data capture apparatus. Said data capture apparatus may come in a plurality of sizes and shapes Said pen-shaped data capture apparatus is comprised of the body 110 and a display and scanner screen 114 in which the user may view digital information regarding settings, information and the functioning of the apparatus itself, as well as use to scan information, including but not limited to text, and other images. Said apparatus contains a USB-style data and scanner port 112 or other type of data port that facilitates a transfer of data from said apparatus to other hardware and/or data processing devices. Said USB-style data and scanner port 112 will facilitate the upload and download of data and/or software from said device and will also encompass the ability to send or receive scanned data and images. Said data capture device contains a battery 118, a wireless radio 120 for transmitting wireless data, and a processor and memory storage 122. Said wireless radio 120, will promote the sending and receiving of wireless data over a plurality of networks, platforms and mediums, including but not limited to Wi-Fi, Bluetooth, GSM, CDMA, 3G and Wi-Max standards. An image and video capture device 124 is connected to an image and video capture lens 126 that enables said apparatus to collect a plurality of images and sounds. Said apparatus contains a retractable stylus tip 128 to facilitate the use of using touch screen devices, including but not limited to wireless mobile devices. Said apparatus contains a retractable writing tip 130, including but not limited to an ink writing tip, as is used by most pens. A retractable device controller 132 is used to retract and protrude said retractable stylus tip 128 and/or said retractable writing tip 130. Said data capture apparatus also includes a global positioning system (GPS) component 134 that will enable said device to be located if lost or misplaced, and it will also facilitate geo-tagging which will capture device location in conjunction with time stamping and data capture and upload. Said device also entails a memory stick port 136 which will allow data to be sent and received from said device by use of a removable memory stick and/or hardware accessory. A microphone—sound port 138 is provided to allow the recording of voice and sound as well as the playback of same or to provide audible instructions or information, including but not limited to alerts, instructions or notifications. An eye-piece-style adaptor 140 further enables said device to connect to various hardware and instruments, including but not limited to microscopes. Said eye-piece-style adaptor will facilitate the collection and storage of data, and said data intended for capture by use of said eye-piece-adaptor 140, and/or said image and video capture lens 126 may be displayed on said display and scanner screen 114 prior to, during, and after said data capture is completed.

What is claimed is:

1. What is claimed is: A method for capturing data, comprising:
enabling a user to gather and collect information and data via multiple inputs and slots on a mobile computing device;
selecting and adjusting system settings on a user interface to aggregate the data into personalized and customized modules;
allowing a user to indicate a secure location to transmit the content and information;
storing a subset of key phrases in a data structure for subsequent searches;
identifying the data structure with tags and phrases for archiving;
generating a mobile record for identification, location, and dates; and
exporting the data into a directory on said mobile computing device, and creating a backup copy which is subsequently transmitted to a secure server digitally coupled to a designated database for synchronization.

2. The method of claim 1 wherein generating a mobile record includes utilizing digital signatures and secure tools for authenticating data and user, and transmitting said data to a subscription notary service for time/data stamping.

3. The method of claim 1 wherein evaluating the captured data comprising categorizing the data and determining what steps, if any, should be taken to develop the captured ideas and information further comprising:
enabling authorized users to gain access to the data for review and consideration;
searching databases to reference similar ideas; and
generating a matrix for comparing and contrasting captured data with prior art.

4. The method of claim 1 wherein facilitating collaboration among authorized users comprising:
enabling designated users to access data and information after completing the authentication protocols;
allowing authorized users to review, input, update, make comments and annotations to data; providing an access code for authorized users from remote locations to interact and make suggestions; and
requiring users to time/date and utilize digital signatures before logging out of the data modules.

5. The method of claim 1 further comprising:
tracking data entries and reviewing the searches and activities within the data structure with audit trails;
confirming updates, entries, input, annotations, and comments of authorized users by transmitting a digital message, including but not limited to text messaging and electronic mail, to said users; and
generating an alert message to designated persons and parties when an unauthorized user has attempted to gain access to a data module for which said user is unauthorized.

6. The method of claim 1 wherein aggregating captured data to facilitate the development and commercialization of patentable ideas comprising:
utilizing customized templates on the user interface and mobile screen to streamline the invention disclosure and patent application filing process; and
enabling idea purveyors to make contributions only after agreeing to the stipulated terms and utilizing digital signatures and time/date stamping.

7. The method of claim 1 wherein presenting content in multiple formats comprising combining applications; e.g., slideshows, video editing, sound, translation, to the aggregated content for generating multimedia presentations, subtitled clips and video streaming, and published reports, including but not limited to PDF formats.

8. The method of claim 1 wherein tagging the captured content with location identifiers comprising verifying the points-of-capture on said mobile device via GPS and geo-location, and matching the captured content with the location(s) of the authorized users.

9. The method and apparatus, as recited in claim 1, wherein said user is capable of performing a single action, to capture and/or upload data objects according to previously-set default settings, including but not limited to the actions of: clicking, pressing and touching a button, including an electronic button on a touch-screen; and emitting a sound or voice print.

10. The method and apparatus, as recited in claim 1, enabling one or more users to profile, select, and agree to share uploaded data from a mobile communication device to a secure server with the purpose of collaborating and facilitating discovery and treatment in real-time.

11. An apparatus that captures, stores, secures, and organizes data and information, tracks entries relevant to one or more user(s) and aggregates said data and information and provides date and time of idea creation and disclosure, and identifies a plurality of users who have accessed, viewed or contributed comments or annotations to said data and information, including but not limited to documents and images.

12. The apparatus as recited in claim 11 that will be able to capture images of multiple sizes and forms including but not limited to written text, standard photographable images and images captured by looking through the lens or viewing area of imaging and data analysis devices and equipment, including but not limited to microscopes, Cytometers, Cyclers and other devices or equipment.

13. The apparatus as recited in claim 11 that will employ variable settings that will be activated by one-touch capability to select and/or toggle between said apparatus's' ability to capture various forms of data, including but not limited to capturing various types of images.

14. The apparatus as recited in claim 11 wherein aggregating captured data is to facilitate the development and commercialization of patentable ideas comprising by utilizing customized templates on the user interface to streamline the invention disclosure and patent application filing process.

15. The apparatus, as recited in claim 11, wherein said user is capable of performing a single action, to capture and/or upload data according to previously-set default settings, including but not limited to the actions of: clicking, pressing and touching a button, including an electronic button on a touch-screen; and emitting a sound or voice print.

16. An apparatus that captures, stores, secures, and sends data and information via wireless transmission means and/or networked means, to facilitate discovery and or innovation. Said apparatus may be in multiple shapes, including but not limited to, the shape of a pen.

17. The apparatus as recited in claim 16 that will be able to capture images of multiple sizes and forms including but not limited to written text, standard photographable images and images captured by looking through the lens or viewing area of imaging and data analysis devices and equipment, including but not limited to microscopes, Cytometers, Cyclers and other devices or equipment.

18. The apparatus as recited in claim 16 that will have the ability to send said data to a mobile and/or handheld device for future compilation of data and facilitation of the discovery process.

19. The apparatus as recited in claim 16 that will employ variable settings that will be activated by one-touch capability to select and/or toggle between said apparatus's' ability to capture various forms of data, including but not limited to capturing various types of images.

20. The apparatus as recited in claim 16 wherein aggregating captured data is to facilitate the development and commercialization of patentable ideas comprising by utilizing customized templates on the user interface to streamline the invention disclosure and patent application filing process.

21. The apparatus, as recited in claim 16, wherein said user is capable of performing a single action, to capture and/or upload data according to previously-set default settings, including but not limited to the actions of: clicking, pressing and touching a button, including an electronic button on a touch-screen; and emitting a sound or voice print.
